(19) United States
(12) Patent Application Publication
(10) Pub. No.: US 2010/0235288 A1
(43) Pub. Date: Sep. 16, 2010

(54) E-COMMERCE USING SWAP

(75) Inventor: Peter Kisbye, Frederiksberg C (DK)

Correspondence Address: KNOBBE MARTENS OLSON & BEAR LLP, 2040 MAIN STREET, FOURTEENTH FLOOR, IRVINE, CA, 92614, US

(73) Assignee: ABSI A/S, Frederiksberg C (DK)

(21) Appl. No.: 12/404,638

(22) Filed: Mar. 16, 2009

Related U.S. Application Data
(63) Continuation-in-part of application No. 12/404,122, filed on Mar. 13, 2009, now abandoned.

(51) Int. Cl. G06Q 30/00; G06Q 20/00

(52) U.S. Cl. 705/80; 705/26; 705/400

(57) ABSTRACT

Some embodiments include a system that enables complex national and international multilateral swaps of goods and/or services over a network, wherein such transactions are carried out using an internal unit of account (IUA) combined with an automatic and secure credit authorization and a deposit routine. The system controls and tracks all accounts, swaps, trades and balances, and enables credit authorization, deposit interfaces for bank transfers, credit card transfers, and internet service providers, trading sites, and/or auction sites.

### CROSS REFERENCE TO RELATED APPLICATION

The present application is a continuation-in-part of and claims the benefit of priority to U.S. patent application Ser. No. 12/404,122, filed Mar. 13, 2009, which is hereby expressly incorporated by reference in its entirety.

### FIELD OF THE INVENTION

Aspects of the present invention relate generally to the field of e-commerce and, more specifically, to the exchange of goods and services between two or more parties.

### BACKGROUND OF THE INVENTION

Using e-commerce virtually any goods and services can be traded. E-commerce can be Business-to-Business (B2B), Business-to-Consumer (B2C) or Consumer-to-Consumer (C2C). Electronic trade can be international whereby seller and buyer will not be in contact with each other. Buyer pays Seller using electronic payment where Buyer transfers the agreed amount of money to an account held by the buyer, and Seller provides the purchased goods or service to the buyer.

Barter is a type of trade in which goods or services are directly exchanged for other goods and/or services, without the use of money. It can be bilateral or multilateral, and usually exists parallel to monetary systems in most developed countries, though to a very limited extent. Barter usually replaces money as the method of exchange in times of monetary crisis, when the currency is unstable and devalued by hyperinflation. E-commerce is also used in barter where seller and buyer swap goods and services without any money being involved. However, such one-to-one swap requires that there is a “Double Coincidence of Wants” for the swap to be performed, which is the situation where the supplier of goods A wants goods B and the supplier of goods B wants goods A. If seller and buyer do not agree that the goods A and B are of the same value they will not swap. Swap trade is therefore not used when goods and services of unequal value are traded. It is desirable to use swap trade or barter also where goods and services of unequal value are traded. The invention provides a solution to this problem.

### SUMMARY OF THE INVENTION

Some embodiments include a system that enables complicated national and international multilateral swaps of goods and/or services to be conducted between millions of users, with speed, security and ease. The system controls, swaps, sales, purchases, credit lines, deposits in escrow accounts, and release of deposits. All functions are conducted in a fast and seamless interface, giving the users quick access to new and expanded trading opportunities.

The complex multilateral swap transactions are carried out using an internal unit of account (IUA) combined with an automatic and secure credit authorization and deposit routine. The system controls and tracks all accounts, swaps, trades and balances, and enables the credit authorization and deposit routine when applicable.

The system has automatic credit authorization and deposit interfaces for bank transfers, credit card transfers and PayPal® transfers and can be adapted to other providers. The user may choose between these at their discretion. The system is platform independent, and may be accessed via PC, PDA, mobile phones or other means.

The system is an add-on module to Trading Sites and/or auction sites on the Internet.

The system is the first to enable millions of users all over the world, to swap goods and services and thus conserve their cash, just as easy as making a credit card payment on the Internet.

### DEFINITIONS USED IN THIS SPECIFICATION

IUA, Internal Unit of Account: To enable the complex multilateral global swaps, the System uses an Internal Unit of Account to facilitate the transactions. The IUA is preferably equal to 1 unit of the currency of the country in which the item is listed. The IUA enables the system to track each individual users swap account balance.

Trading Site Trading Sites are sites available today, or introduced in the future that conducts Internet based trade such as e-commerce between B2B, B2C or C2C users. Examples today are, Amazon®, eBay®, Yahoo® etc.

Access device: is any suitable means for accessing a Trading Site. The access device may be a wired or wireless device such as a desktop or laptop computer, a PDA, a cell phone, a commercial terminal etc.

Transaction facility: is a facility e.g. at a Trading Site that handles all transactions between users, in particular buyers and sellers, using a System as described herein.

Swap: A swap is a trade between 2 or more parties where the payment is made in other goods and/or services.

Provider: One or more providers of Internet payment solutions. For example, MasterCard®, Amex®, Banks and PayPal®.

The System: The software, hardware and/or business solutions of the invention as disclosed in this specification.

Swap account: Each user has an account in The System that tracks real-time balance between sales and purchases made. The difference is the “swap balance” This may be positive (the user has sold more than he/she has bought) or negative (the user has bought more than he/she has sold).

Swap escrow account: In order to avail the users of a swap credit line, the system has an automatic credit authorization and deposit routine, where the user makes a deposit to secure a swap credit line. This deposit can be placed e.g. in an escrow account in the user's name.

Swap credit line: The amount of IUA that the user may draw below 0 (zero) to make trades in The System.

Credit risk: In order for a multilateral swapping system to start and function, someone must owe the system goods and or services. If everyone can only sell no sales can take place. The required negative balance in some accounts is a credit risk for the Trading Site.

It is often not a lack of interest or business opportunity that stops a potential trade from being conducted, but the lack of money. If people all over the world, could purchase needed goods and/or services by swapping their own goods and or services, global trading opportunities would be increased. The traditional barter trades are used in all countries, but they are very limited in their scope, as they require a double coincidence of wants between Buyer and Seller and usually also close geographic proximity. If a fisherman wants a new car, he must find a car dealer who is in the market for quite a lot of fish—an unlikely occurrence. Of course the traditional solution to this problem is using money, but this also ads complications. The problem of scarcity, exchange rates, high interest, problems getting credit, recessions, financial crises etc, all reduce trading, as the availability of money is restricted in one way or another.

With the globalization and the Internet, new trading solutions are now possible, and this trading system, enables people all over the planet, to use their own goods, services and talents to purchase what they need and want, by swapping their own goods and or services without requiring a double coincidence of wants and just as easy, as any other business transaction on the Internet. Most people and/or businesses would prefer the swapping of goods and/or services to paying in cash, if this was possible in an easy and secure fashion.

In some embodiments, the system allows for:

Buying

1. The Buyer uses a Trading Site as she/he would normally do.

2. Some listed items will display a “swap” button, indicating the possibility of swapping for the item listed instead of paying cash.

3. When the purchase is complete buyer may select “swap” as the payment option.

4. The system checks if buyer has a “swap account”, if not, one is opened.

5. The system checks amount in IUA at buyer's disposal in buyers swap account:

If OK, payment is made to seller's swap account in IUA.

If NO, automatic credit authorization and deposit routine starts:
Buyer secures swap credit line by deposit (via CC, Bank, and PayPal® etc.),
Deposit is held in escrow account in buyer's name,
If deposit is OK, then credit line is OK and payment in IUA is completed.

Selling

1. Buyer (now the Seller) uses the Trading Site as she/he would normally do and lists item(s) for sale.

2. Seller may select “swap” as a payment option offered on item(s).

3. System checks if seller has “swap account”, if not, one is opened.

4. Auction, “buy now” or fixed price sale, run as usual on the Trading Site.

5. Seller receives payment in IUA for the sale—sale complete.

6. Upon completion, the system checks for deposit status and possible refund.

7. Seller selects option (none, maximum or amount).

8. Deposit refunded into clients account, including accrued interest if applicable.

9. Swap is complete.

One user of the Trading Site has now swapped with another, both users getting the items desired, without having spent any cash.

Aspects of the invention enable global multilateral swapping of good and services by private persons and/or companies. The system is an add-on to Trading Sites, where anyone can offer their goods and/or services to the global marketplace. The system can be added to any Trading Site regardless of technology used on said Trading Site. The buyer/seller uses the Internet Trading Site platform of choice (i.e. Amazons®, eBay®, Yahoo® etc), and conducts the selling or buying process as prescribed the site in use. The system, offers the extra advantages, of enabling swapping as a means of payment, thus increasing business opportunities for both seller and buyer.

Aspects of the invention eliminate the need for a double coincidence of wants from the process. By using an internal unit of account (IUA), the system eliminates the need for a double coincidence of wants from the trading process. All customers who list an item are at the same time given a swap account held in IUA. All goods and services are priced normally and are listed for swap in IUA. Seller receives payment in IUA, and has a record of this in his IUA account. The IUA are then used to purchase the items Seller wanted, and the swap is completed. Thus Sellers can swap-sell to one person, while swap-buying from one or more others. One IUA is preferably equal to one unit of the national currency in the country of transaction.

If a car salesman in Ohio wants to swap for several sets of chrome wheels from India, he may obtain IUA by swapping the car to a lady in California; he then uses the IUA to swap with the Wheel factory in India, which in turns uses the IUA to swap for paint from France.

Aspects of the invention eliminate the problem of credit risk. In order for a multilateral swap to occur, someone must be able to buy, i.e. have credits on the account. To do this initially, someone must draw on their account and have a negative balance, which gives The System a credit risk. In a global environment, with millions of users, this must be handled automatically, as an individual credit approval is not a viable option in a system based on a very high volume of transactions many at limited amounts. The system solves this problem.

Aspects of the invention solve the problems associated with complicated multilateral global swaps, in an easy secure and efficient manner. Using the system, the IUA feature combined with the automatic credit authorization and deposit routine anyone can easily and securely swap goods all over the globe.

Aspects of the invention solve the problem of pricing and/or setting a value of swap trades. By using an IUA the system enables the pricing and/or setting a value of the good/services offered for sale on the trading site. Traditionally, each user has made his/her own evaluation of whether e.g. the value of 3 lawnmowers was equal to the value of 1 new flat screen TV. This makes trading cumbersome and inefficient, thus hindering or limiting trading opportunities. Furthermore, the lack of a set value and/or price makes it impossible for a Trading Site to set and/or apply relevant fees based on the value of the trade conducted. By using IUAs and requiring each user to set a value on items listed for trade (e.g. the same price they would sell for in cash) the invention solves this problem. If several users offer similar items for sale it may be an advantage if the items have similar, if not identical, prices. The System may therefore suggest a price or a price interval. Aspects of the invention make swap deals as easy and efficient as any trade paid by other means, both for the seller and the buyer, and also for the trading site.

Accordingly, preferred embodiments include a computer-implemented method comprising:
receiving from a first user and in an electronic device a purchase request indicating that the first user wants to purchase a first item at a first price;
communicating via a network the purchase request to a transaction facility;

and either
receiving from the transaction facility and via the network a confirmation of the purchase request;

or
receiving from the transaction facility and via the network a statement that an amount at the disposal of the first user is less than the first price;
communicating via the network to the first user the statement that the amount at the disposal of the first user is less than the first price;
receiving a deposit of an amount resulting in the amount at the disposal of the first user corresponding at least equal to the first price; and
receiving from the transaction facility and via the network a confirmation of the purchase request;

and
communicating via the network the confirmation of the purchase request to the first user;
receiving from the transaction system information that the amount at the disposal of the first user has been reduced by an amount corresponding to the first price; and

communicating to the first user information that the amount at the disposal of the first user has been reduced by an amount corresponding to the first price.

Some embodiments also include the aforementioned methods further comprising:

receiving from the first user an offer to sell a second item at a second price;

communicating to the transaction facility the offer to sell the second item;

receiving from the transaction facility a second user's acceptance of buying the second item at the second price, and information that the amount at the disposal of the first user has been increased by an amount corresponding to the second price; and

communicating to the first user the second user's acceptance of buying the second item and information that the amount at the disposal of the first user has been increased by an amount corresponding to the second price.

More embodiments include a computer-implemented method comprising

receiving via a network in an electronic device an offer from a first user to sell a first item at a first price;

communicating via a network to a transaction facility the offer to sell the first item;

receiving from the transaction facility and via the network a second user's acceptance of buying the first item at the first price; and

communicating to the first user the second user's acceptance of buying the second item and information that an amount at the disposal of the first user has been increased by an amount corresponding to the second price.

Still more embodiments include a computer-implemented method comprising, in a transaction facility:

receiving via a network and in an electronic device a first user's request to buy a first item at a first price;

determining in the electronic device whether an amount at the disposal of the first user corresponds to at least the first price;
and either

if the amount at the disposal of the first user corresponds to at least the first price, communicating a confirmation of the purchase request;
or

if the amount at the disposal of the first user does not correspond to at least the first price, communicating a request for depositing an amount resulting in the amount at the disposal of the first user to correspond at least to the first price;

receiving a deposit of an amount resulting in the amount at the disposal of the first user to correspond at least to the first price; and

communicating the confirmation of the purchase request to the first user;
and

communicating to the first user information that the amount at the disposal of the first user has been reduced by an amount corresponding to the first price.

In some embodiments, the aforementioned methods further comprise the steps of:

receiving an offer of the first user to sell a second item at a second price;

receiving a second user's acceptance of buying the second item at the second price;

communicating to the first user the second user's acceptance of buying the second item and information that an amount at the disposal of the first user has been increased by an amount corresponding to the second price; and

communicating to the second user information that the amount at the disposal of the second user has been reduced by an amount corresponding to the second price.

### BRIEF DESCRIPTION OF THE DRAWINGS

FIG. 1 is a simplified block diagram of an exemplary e-commerce system using the invention.

FIG. 2 is a flow chart illustrating an exemplary method of a buyer purchasing an item.

FIG. 3 is a flow chart illustrating an exemplary method of a seller selling an item.

FIG. 4 is a flow chart illustrating an exemplary method of seller notification and deposit return.

### DETAILED DESCRIPTION

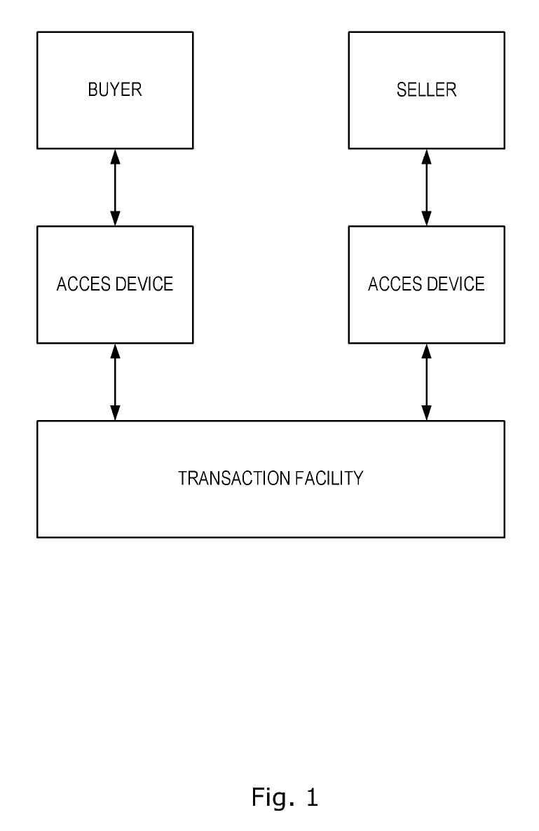

In FIG. 1 is illustrated the main blocks of a system 100 using the invention. The system 100 includes a transaction facility 110 with one or more access devices 120 coupled to the transaction facility 110. Each access device 120 can be personal handheld device like a cell phone or a PDA (personal digital assistant), or it can be a laptop or desktop computer with wired or wireless connectivity to the transaction facility 110, e.g. via the Internet, or a terminal that is ad hoc or hard wired connectable the transaction facility 110. Such terminals may be provided by the operator of the transaction system or other entities different from the users of the terminals. The transaction facility 110 has a memory storing a register or a database of items offered for sale by sellers. The transaction facility 110 may also have a memory storing a register or a database of items wanted by one or more buyers. The transaction facility 110 has a system for controlling transactions between multiple buyers and sellers including an accounting system. Items that are traded using the invention include all kinds of goods and services. A user such as a buyer or a seller who wishes to access the transaction facility 110 uses an access device 120 to access the transaction facility 110.

A user who wishes to purchase an item whether he or she eventually does purchase the item or not is herein referred to as a buyer. Likewise, a user who wishes to sell an item whether he or she eventually does sell the item or not is herein referred to as a seller.

Buyer's Purchase of an Item Offered for Sale

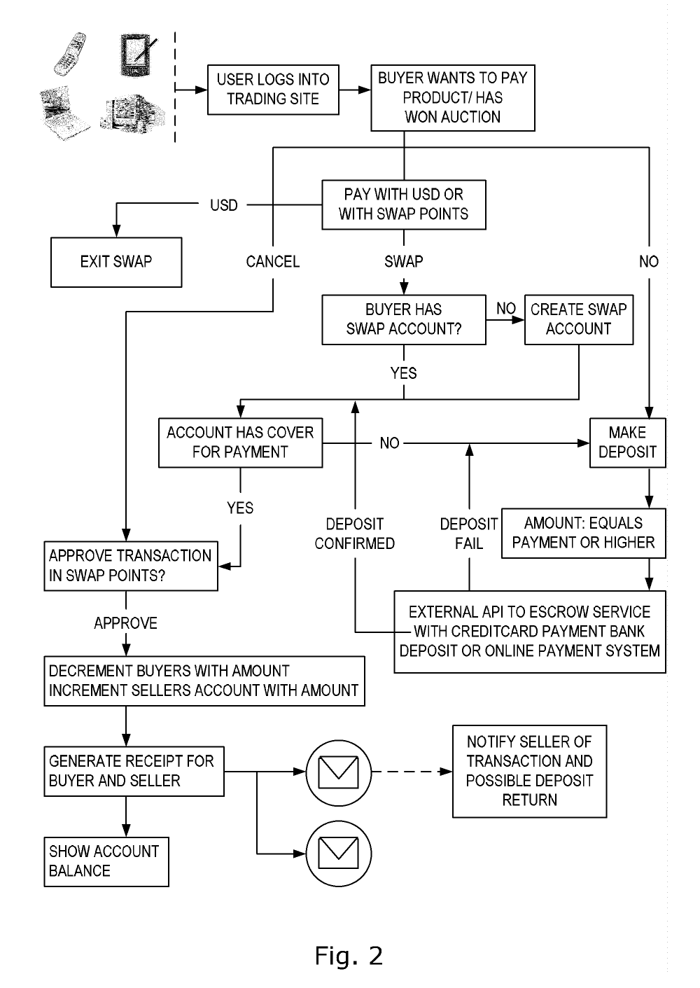

Reference is now made to the flow chart in FIG. 2.

a. Buyer uses an available access point to the transaction facility of the Trading Site of choice.

b. Buyer enters the Trading Site and logs on in accordance with the Trading Sites polices etc.

c. Buyer searches for the items of interest offered for sale, using the search technology and functions provided by the Trading Site.

d. Buyer selects one or more items of interest on the Trading Site. Depending on the specific Trading Site, this may be a straight purchase (i.e. at a fixed price), an auction, and an auction with a “buy now” feature, a reverse auction, or other formats available on the Trading Site.

e. Once either the auction is won, or “buy now” is chosen, or the fixed price is accepted, or Buyer in other ways completes the purchase, Buyer chooses between the available methods of payment on the Trading Site. This may be cash, credit card, bank transaction, PayPal® or any other suitable method made available by the Trading Site. If the System of this invention is implemented swap is one option. On most Trading Sites, available means of payment on a given sale are chosen by Seller from a list of alternatives offered by the Trading Site. If the invention is implemented by the Trading Site swap will be available as an option to Seller. The available methods of payment on any given sale are decided by Seller in accordance with the individual Trading Sites policies.

f. If Buyer chooses other options than swap, the traditional routines and functions of the Trading Site apply and the invention is no longer involved in the transaction.

g. If Buyer chooses swap as payment, e.g. by clicking a “swap” icon the System initiates the following routine.

h. The System checks, if Buyer already has opened a swap account on the Trading Site in question. A swap account may be Trading Site specific or applicable to several Trading Sites.

If Buyer already has opened a swap account, the System proceeds to step j.

i. If Buyer has not opened a swap account, the system initiates an “open account” routine. The required information for opening an account is Trading Site specific. The minimum requirement for The System is, e.g., name, address, email and phone no. When this is completed, the system proceeds to step j.

The system checks if Buyer has an amount in IUA at his disposal in his swap account, that is equal to or larger than the purchase price in IUA for the item to be purchased, i.e. if swap account balance is greater than or equal to purchase amount the system proceeds to step k. If swap account balance is less than purchase amount the system enables the automatic credit authorization and deposit routine. This automatically offers Buyer a swap credit line in IUA in order for him to complete the first phase of the swap.

The system calculates the amount in IUA needed to complete the trade in question. The System initiates the following steps to complete the automatic credit authorization and deposit routine:

i. Calculates amount needed to complete the transaction.

ii. Credit line in IUA is offered to buyer. Minimum amount required to complete the trade is default, but Buyer can choose a larger amount.

iii. Buyer secures the credit line; by making a deposit in the amount selected in “iii” into his/hers swap escrow account.

iv. The System offers Buyer one or more options for the depositing determined by the Trading Site, for example:

Credit card

Bank transfer

Western Union®

PayPal®

Pro Pat®

DIBS®

Others

v. Buyer selects the option of choice, and approves the deposit into the swap escrow account.

vi. The System communicates with the selected provider. Once the system receives OK on the deposit, a swap credit line in the same amount is established automatically.

If response from provider on deposit is negative (i.e. Buyer has insufficient funds for deposit), Buyer is offered to use another source for deposit, or may abandon the swap.

k. Buyer approves the payment of IUA, and the amount is transferred from the buyers swap account to Sellers swap account. Seller and buyer are notified e.g. by email or SMS as applicable.

l. Records and balances in sellers and buyers swap account are updated real time.

m. Buyer now has a negative IUA balance, as only the first phase of the swap is completed, in this case the purchase phase. Buyer will now put items of for sale—see selling below.

n. When m is completed, Buyer has acquired the item he wanted, and paid by swapping with goods/services they are in the business of selling or no longer need. End Buying.

Seller Selling an Item or Offering it for Sale

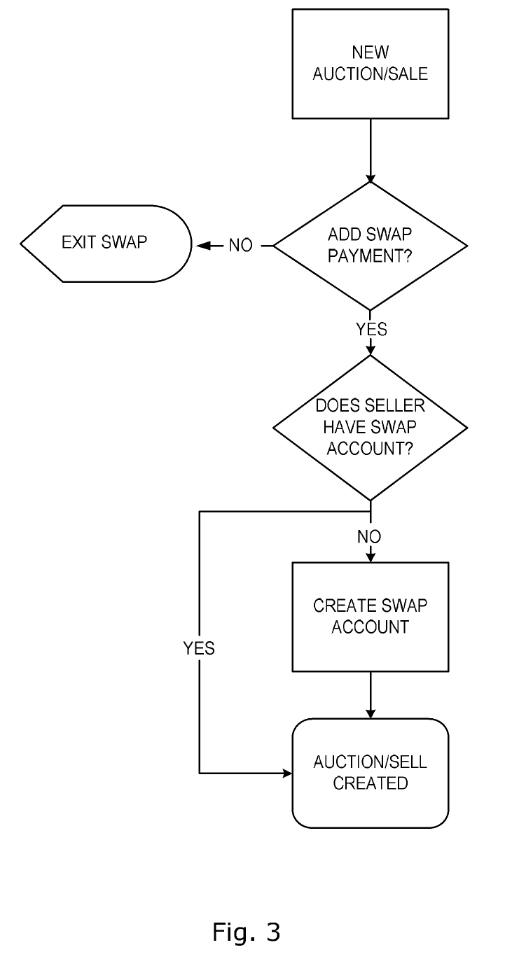

Reference is now made to the flow chart in FIG. 3.

a. Seller uses an available access device to access the Trading Site of choice.

b. Seller enters the Trading Site and logs on in accordance with the Trading Sites polices etc.

c. Seller lists item or items that he/she wants to sell. The listing is according to the offers, and procedures of the Trading Site in question.

d. If the Trading Site has implemented the invention the Trading Site can offer Swap as an option for trading and payment to its users.

e. Seller may now choose which methods of payment will be available to

Buyers on the given sale. Seller chooses between the alternatives made available by the Trading Site.

f. If Seller chooses not to offer a swap on this item then the System is not involved in the transaction.

g. If swap is offered as an option by Seller, then the System proceeds to h.

h. The System checks, if Seller already has opened a swap account on the trading site in question. A swap account may be Trading Site specific or applicable to several Trading Sites.

i. If Seller already has opened a swap account, the system proceeds to step k.

j. If Seller has not opened a swap account, the system initiates an “open account” routine. The required information for opening an account is Trading Site specific. When this is completed, the system proceeds to step k.

k. Seller's item is now listed on the Trading Site and swap is offered on this item. How this is displayed/communicated to the buyers viewing the item is Trading Site specific.

l. If item is unsold—end.

m. If item is sold, but Buyer chooses a payment option other than swap, The System is not involved in the transaction.

n. If swap is chosen as payment option, system proceeds to o.

o. This is triggered by the buyer's approval of the transaction.

p. The payment of IUA is approved, and the amount is transferred from the buyers swap account to Sellers swap account. Seller and buyer are notified e.g. by email or SMS as applicable.

q. Records and balances in sellers and buyers swap account are updated real time.

r. Upon completion of q, The System automatically initiates the automatic deposit refund routine.

s. Automatic deposit refund routine after every completed swap on the Trading Site.

i. If seller does not have deposit in escrow, end.

ii. If seller has deposit in Swap Escrow account The System proceeds to t.

t. The System checks the maximum possible deposit refund (The amount that would set the Swap credit in IUA=0).

u. The System asks seller if they want deposit released or leave it in the escrow account.

If seller chooses to leave deposit in escrow, and thereby maintain the current swap credit limit no further action is taken, a transaction is completed.

If seller chooses “return deposit” The System proceed to v.

v. The System asks seller if he/she wants maximum deposit amount released (i.e. setting the IUA credit limit to Zero) or a specific amount less than the maximum amount.

w. Once selection is made, the system communicates with the chosen deposit provider (i.e. credit card, bank PayPal® etc) and automatically releases deposit from the swap escrow account into clients account.

x. Once the System releases the deposit, the system updates the IUA credit limit accordingly. I.e. a 1,000 USD release of deposit reduces IUA credit limit by 1,000

y. The swap is completed.

The Server Handling Swap Trades

All operations on the server of the transaction facility in relation to the current user are implemented using the user's unique identifier in the trading system (hereafter called UID). IUA (Internal Unit of Account) is the currency used in the trades.

1. Creating a Swap Account on the Server:

a. The UID in the trading system is transferred to the server.

b. The server registers the user by the UID.

c. The server creates an account for the IUA associated with the UID.

d. The swap account has an initial balance of zero IUA.

2. Validating Sufficient Balance:

a. The trading system transfers the UID and the value of the total amount of IUA for the payment.

b. The server looks up the current balance of IUA in the account associated with the UID.

c. The server compares the current balance to the total amount for the payment:
i. If the current balance is less than the total amount for the payment, the server checks if the user has an escrow account configured.
ii. If the user has an escrow account configured, the server communicates with the escrow service to find out the balance of the user's associated escrow account.

d. If the current balance of IUA or the sum of the balance of the escrow account and the balance of IUA (swap credit line) is equal to or higher than the amount for the payment, the server sends back a response to the trading server, that the account balance is sufficient.

e. Otherwise the server sends back a response to the trading server that account balance is insufficient.

3. Making a Deposit into the Escrow Account:

a. If the user has an existing escrow account registered the deposit will be added to this account. Otherwise a new escrow account will be added.

b. The server communicates with the escrow service the amount for deposit and the possible existing account.

c. The external escrow service handles the possible creation of a new escrow account or the identification of an existing account and the payment from the user by preferred choice.

d. The server receives a response from the escrow service of either successful or failed completion of deposit.

e. If deposit is successful the server returns to validating sufficient balance (2).

f. If deposit fails the server returns to making a deposit into the escrow account.

4. Completion of a Transaction:

a. The transaction is stored separately with at least an associated timestamp and an automatically generated transaction ID.

b. The server completes a transaction by registering the payment amount in IUA as a debit transaction on the sellers swap account and a credit transaction on the buyers swap account associated with the transaction ID.

5. Find Account Balance and Swap Credit Line:

a. The server receives the UID and generates the current balance in IUA for the user as a sum of all movements on the account incl. the latest transaction.

b. If the user has an escrow account configured, the server communicates with the escrow service to find out the balance of the user's associated escrow account.

c. The total disposable amount (swap credit line) is calculated as the sum of the balance of the account and, if relevant, the balance of the escrow account.

6. Generate Receipts and Notify the Seller:

a. Display a receipt for the buyer with all known transaction data and current account balance and disposable amount.

b. E-mail an equivalent receipt to the buyer.

c. E-mail a receipt to the seller:
i. The e-mail contains the equivalent transaction data and current account balance and swap credit line for the seller.
ii. If seller has an escrow account, the e-mail contains a link to redeem some or all of the deposit. This functionality is described separately.

The Server Handling Deposit Return

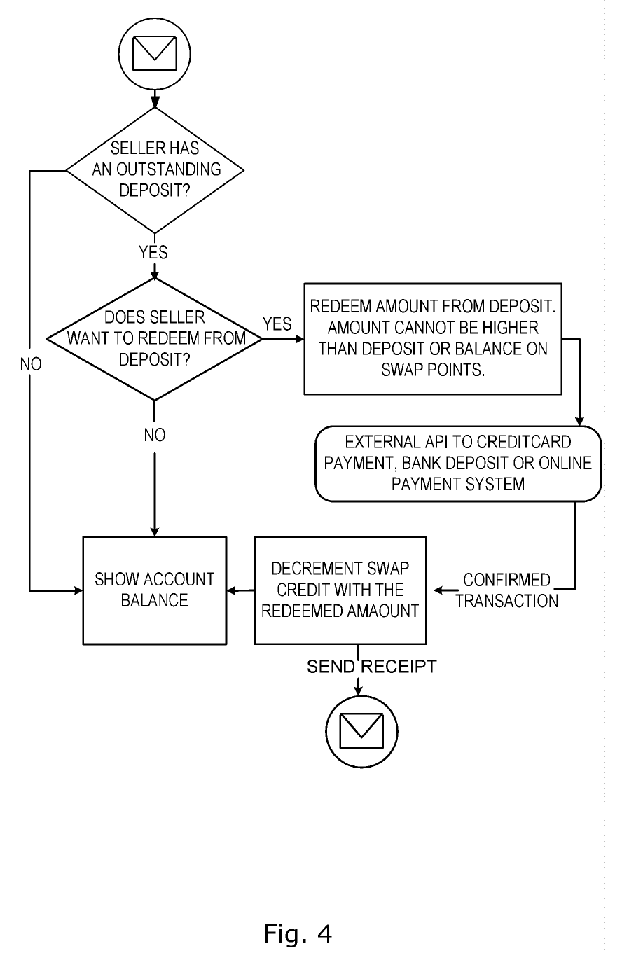

Reference is now made to FIG. 4. Prior to this, the user will have selected an option of redeeming some or all of the user's deposit. Some or all of the following operations are performed.

1. The server communicates with the escrow service to find out the balance of the user's associated escrow account.

2. The server returns information on a maximum redeemable amount:

a. This amount is equal to the minimum value of either:
i. the value of the swap credit line on the swap account or
ii. the value of the current balance of the escrow account.

3. The server receives information on an amount to be redeemed.

4. The server communicates with the escrow service to release the selected amount from the deposit associated with the current user.

a. This transaction is handled solely by the escrow service.

5. The server receives a status of the transaction request from escrow service.

6. If deposit transaction has been completed successfully, the user's swap credit line is recalculated:

a. The server communicates with the escrow service to find out the balance of the user's associated escrow account.

b. The swap credit line is calculated as the sum of the balance of the swap account and the balance of the escrow account.

7. The server sends an e-mail to the user with a confirmation of the deposit return and the new swap credit line.

8. The server displays a confirmation of the deposit return and the new swap credit line.

It should be noted that each of the steps listed here need not be performed for practicing the invention. Further, when practicing the invention the steps may be performed in a different sequence than what is described above, and the timing of the steps performed may include a time interval between steps. Thus, there may be a time interval between the time when a user offers an item for sale and the time when another user buys the item. In some cases such time interval can be up to several days and possibly longer.

In many countries, e.g. the US, swap meets and flea markets are very popular. The system is adapted to Blackberry®, iPhone® etc, with a mobile platform that enables visitors to meets to swap on the spot, if the both have a swap account.

Aspects of the invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, some embodiments may be implemented in a single unit, or may be physically and functionally distributed between different units and processors.

What is claimed is:

1. A computer-implemented method comprising:
receiving from a first user and in an electronic device a purchase request indicating that the first user wants to purchase a first item at a first price;
communicating via a network the purchase request to a transaction facility;
and either
receiving from the transaction facility and via the network a confirmation of the purchase request;
or
receiving from the transaction facility and via the network a statement that an amount at the disposal of the first user is less than the first price;
communicating via the network to the first user the statement that the amount at the disposal of the first user is less than the first price;
receiving a deposit of an amount resulting in the amount at the disposal of the first user corresponding at least equal to the first price; and
receiving from the transaction facility and via the network a confirmation of the purchase request;
and
communicating via the network the confirmation of the purchase request to the first user;
receiving from the transaction system information that the amount at the disposal of the first user has been reduced by an amount corresponding to the first price; and
communicating to the first user information that the amount at the disposal of the first user has been reduced by an amount corresponding to the first price.

2. The method according to claim 1 further comprising:
receiving from the first user an offer to sell a second item at a second price;
communicating to the transaction facility the offer to sell the second item;
receiving from the transaction facility a second user's acceptance of buying the second item at the second price, and information that the amount at the disposal of the first user has been increased by an amount corresponding to the second price; and
communicating to the first user the second user's acceptance of buying the second item and information that the amount at the disposal of the first user has been increased by an amount corresponding to the second price.

3. A computer-implemented method comprising
receiving via a network in an electronic device an offer from a first user to sell a first item at a first price;
communicating via a network to a transaction facility the offer to sell the first item;
receiving from the transaction facility and via the network a second user's acceptance of buying the first item at the first price; and
communicating to the first user the second user's acceptance of buying the second item and information that an amount at the disposal of the first user has been increased by an amount corresponding to the second price.

4. A computer-implemented method comprising, in a transaction facility
receiving via a network and in an electronic device a first user's request to buy a first item at a first price;
determining in the electronic device whether an amount at the disposal of the first user corresponds to at least the first price;
and either
if the amount at the disposal of the first user corresponds to at least the first price, communicating a confirmation of the purchase request;
or
if the amount at the disposal of the first user does not correspond to at least the first price, communicating a request for depositing an amount resulting in the amount at the disposal of the first user to correspond at least to the first price;
receiving a deposit of an amount resulting in the amount at the disposal of the first user to correspond at least to the first price; and
communicating the confirmation of the purchase request to the first user; and
communicating to the first user information that the amount at the disposal of the first user has been reduced by an amount corresponding to the first price.

5. A method according to claim 4 further comprising
receiving an offer of the first user to sell a second item at a second price;
receiving a second user's acceptance of buying the second item at the second price;
communicating to the first user the second user's accept of buying the second item and information that an amount at the disposal of the first user has been increased by an amount corresponding to the second price; and
communicating to the second user information that the amount at the disposal of the second user has been reduced by an amount corresponding to the second price.
